(19) United States
(12) Patent Application Publication
(10) Pub. No.: US 2014/0026977 A1
(43) Pub. Date: Jan. 30, 2014

(54) CHEMICAL PRECURSOR BUBBLER ASSEMBLY

(71) Applicants: William Kimmerle, Hudson, OH (US); Kyle Kimmerle, Portland, OR (US)

(72) Inventors: William Kimmerle, Hudson, OH (US); Kyle Kimmerle, Portland, OR (US)

(21) Appl. No.: 13/950,647

(22) Filed: Jul. 25, 2013

Related U.S. Application Data
(60) Provisional application No. 61/675,475, filed on Jul. 25, 2012.

(51) Int. Cl. B01F 3/02

(52) U.S. Cl. CPC B01F 3/02
USPC 137/98

(57) ABSTRACT

One or more techniques and/or systems are disclosed for saturating a gas with a liquid-borne compound. A bubbler container may be configured to contain a carrier liquid, which comprises a desired compound. The container may comprise at least one routing plane, disposed between the top and bottom of the container, which may be configured to allow gas bubbles to travel through a circuitous, routing route. The gas can be introduced to the container at a bottom portion of the container, into the carrier liquid comprising the compound. Carrier gas bubbles formed in the liquid may be forced to travel the routing route to a top portion of the container, where gas saturated with the compound may be collected.

### BACKGROUND

Apparatuses and systems for generating carrier gas stream containing a desired compound, under controlled environment conditions, are used in a variety of industries. For example, “bubblers” are often used in the electronics fabrication industry, particularly when manufacturing semiconductors, integrated circuits, computer chips and LEDs. A carrier gas saturated with the desired compound may be delivered to processing equipment that provides for deposition of the compound to form layers and/or films, for example. The carrier gas may be saturated with the desired compound by “bubbling” it through a container comprising a solid or liquid precursor that comprises the desired compound.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Gas bubbler containers that utilize a solid-source precursor for saturating a carrier gas with a desired compound (e.g., as a vapor) can exhibit poor saturation rates of the collected carrier gas and/or poor consumption rates of the precursor material. These problems, for example, may be a result of channels forming in the precursor material, which can lessen exposure length and/or time of the carrier gas with the precursor. Further, for example, progressive reduction in a total surface area of the precursor material can occur during “bubbling,” which can also lessen contact of the carrier gas with the precursor. Additionally, re-entrainment of a saturated compound to the solid precursor may occur in areas of the bubbler where exposure to the carrier gas is reduced, which may reduce a consumption level of the desired compound from the precursor.

Additionally, filling and/or cleaning of a “bubbler” can comprise a laborious and often expensive process. Accessing an inside portion of the bubbling container is often very difficult, which makes loading and/or cleaning of the container very difficult; often requiring special processes and tools.

Accordingly, among other things, one or more apparatuses and/or systems are disclosed for running a gas through precursor material using a bubbler container that can be configured to increase a travel route (e.g., and therefore potentially increase an exposure time) of a carrier gas through the solid-source precursor material. For example, creating a circuitous route for the carrier gas to travel through the precursor can help improve the effectiveness of a bubbling container. Further, a container may be configured with a selectively removable top wall (e.g., lid), such that an interior portion of the container (e.g., and bubbling tube) may be easily accessed for loading of precursor and/or cleaning the interior of the container.

In one implementation, an apparatus for running a gas through precursor material may comprise a container that comprises a selectively removable top wall, where the container can be configured to house a bent tube. Further, the bent tube can be configured to contain a solid precursor material. The tube may comprise a gas inlet, a gas outlet, and a selectively removable top portion configured to provide access to an interior portion of the tube.

In another implementation, a system for running a gas through precursor material may comprise a container that comprises a selectively removable top wall, where the container can be configured to receive a routing structure. Further, the routing structure may be configured to be selectively removable from the container. Additionally, the routing structure may be configured to direct a flow of the gas through the precursor material using a desired route.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a component diagram illustrating an exemplary apparatus for running a gas through precursor material.

FIG. 2 is a component diagram illustrating an example implementation where one or more portions of one or more apparatuses described herein may be implemented.

FIG. 3 is a component diagram illustrating an example implementation where one or more portions of one or more apparatuses described herein may be implemented.

FIG. 4 is a component diagram illustrating an example implementation where one or more portions of one or more apparatuses described herein may be implemented.

FIG. 5 is a component diagram illustrating an example implementation where one or more portions of one or more apparatuses described herein may be implemented.

FIG. 6 is a component diagram illustrating an example implementation where one or more portions of one or more apparatuses described herein may be implemented.

FIGS. 7A-7D are component diagrams illustrating example implementations where one or more portions of one or more apparatuses described herein may be implemented.

FIG. 8 is a component diagram illustrating an example implementation where one or more portions of one or more apparatuses described herein may be implemented.

FIG. 9 is a component diagram illustrating an example implementation where one or more portions of one or more apparatuses described herein may be implemented.

FIGS. 10A and 10B are component diagrams illustrating example implementations where one or more portions of one or more apparatuses described herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Vapor exchange bubblers utilizing a solid-source precursor, such as for metalorganic chemical vapor phase epitaxy (MOVPE), can exhibit undesirable properties that may lead to less than desirable results, such as a poor saturation rate of a desired compound from the precursor to a carrier gas. As an example, during “bubbling,” the saturation rate of the desired compound to the carrier gas may decline sharply well before most of the desired compound has been consumed in the solid-source precursor. Further, as an example, a concentration of the desired compound (e.g., as a vapor) in the resulting “saturated” carrier gas may be less than desirable (e.g., for MOVPE use).

Undesirable properties exhibited by a solid-source bubbler may be a result of “channeling,” for example, where the carrier gas effectively tunnels through the precursor material, thereby lessening contact of the carrier gas with the precursor. This tunneling or channeling can result in incomplete usage (or consumption) of the solid precursor. Further, progressive reduction in a total surface area of the precursor, from which sublimation of the desired compound may take place, can occur during “bubbling” (e.g., caused by agglomeration of the precursor), which can also lessen contact of the carrier gas with the precursor. Additionally, re-entrainment of the desired compound to the solid precursor may occur in areas of the bubbler where efficient contact with the carrier gas is reduced, which may reduce a consumption level of the desired compound from the precursor.

In order to mitigate these problems and/or the effects of the problems, a bubbler container may be configured to increase a travel route (e.g., and therefore potentially increase an exposure time) of a carrier gas through the solid-source precursor material. As one example, forcing the carrier gas to travel a circuitous route through the precursor material may mitigate channeling of the precursor material, may aid in mitigating the effects of reduced surface area of the precursor material, and may mitigate re-entrainment of the desired compound to the precursor material.

In one aspect, in order to increase the travel route of the carrier gas through the precursor material, a bubbler container may comprise a winding tube (e.g., or series of tubes) that snakes back and forth (e.g., and/or up and down) inside the container. In one implementation in this aspect, the container may comprise a desired dimension, and the tube may be configured to wind back and forth inside the container in a manner that can efficiently utilize the available space inside the container, in accordance with the desired dimension. Further, in this implementation, a gas inlet may be disposed at a first end of the tube, and a gas outlet may be disposed at a second end of the tube.

In one implementation, different portions of the tube may comprise different interior dimensions (e.g., diameter). As one example, a first portion of the tube, disposed near the gas inlet, may be configured to comprise a larger interior dimension than a second portion of the tube, disposed near the gas outlet. That is, for example, the tube may be configured to progressively narrow as it nears the gas outlet. Progressively narrowing (e.g., or increasing) the interior dimension of the tube as it approaches the gas outlet may provide for improved saturation efficiency of a desired compound into the carrier gas and/or consumption efficiency of the desired compound from the precursor material, for example.

In one implementation, the container (e.g., comprising a top wall, bottom wall and one or more side walls) may be comprised of stainless steel, or another appropriate material (e.g., one that may not react with the precursor, desired compound, and/or carrier gas). In one implementation, the tube may also be comprised of stainless steel, or another appropriate material. As one example, the container body (e.g., comprising the side wall) may comprise a cylinder that is formed as a large tube that is sized (e.g., cut) to a desired dimension. As another example, the container body can be formed (e.g., machined to a desired dimension) from a metal sheet that is welded (e.g., or otherwise joined, bonded, etc.) along a seam to form the cylinder shape. As another example, two or more container body portions (e.g., cylinder sections) may be stacked and joined (e.g., welded) to form a single container body.

In one implementation, the bottom wall of the container may be formed from a metal sheet, which can be joined (e.g., welded) to the container's side wall(s). The tube, configured in a winding (e.g., up and down and/or back and forth) formation, may be located in the container (e.g., cylinder) comprising, at least, the side wall(s) and the bottom wall, for example; and a top wall may be attached at the top of the container's side wall(s). In one implementation, the top wall may be formed from a metal sheet, and the top wall can be attached to the side wall(s) in a manner that allows the top wall (e.g., lid) to be selectively removable.

In one implementation, a top portion of the tube may be selectively removable. As one example, the tube may comprise one or more portions that are disposed at or near a top portion of the container (e.g., corresponding to the winding formation). In this example, a top portion of the tube may be selectively removable, such that, when removed, an interior portion of the tube can be accessible for cleaning, removal of a precursor material, and/or insertion of the precursor material. In one implementation, the selectively removable top portion of the tube may be attached to a selectively removable top wall (e.g., lid). That is, for example, a lid of the container may be selectively removable and, when removed, the top portion of the tube may also be removed with the lid to effectively access the interior portion of the tube (e.g., for cleaning the tube and/or loading of a precursor).

In one implementation, a portion of the container that meets the selectively removable top wall may comprise a sealing means, such as a tight-fitted joint and/or a gasket of suitable material (e.g., non-reactive material, such as a flexible polymer or a flexible mineral gasket). Further, in one implementation, a portion of the selectively removable top portion of the tube that meets the bottom portion of the tube may comprise a sealing means, such as a tight fitting joint and/or a suitable gasket. As one example, the sealing means (e.g., for the container and/or the tube) can be used to mitigate gas leaking into and/or out of the container and/or tube, such that efficient “saturated” gas collection may occur when a carrier gas is “bubbled” through the tube, and/or contaminant gases (e.g., air) are mitigated from introduction into the “bubbling” process.

In one implementation, the container may comprise a fastening means, such that the top wall may be selectively fastened to the container body (e.g., securing the seal between the lid and the container and/or the top potion of the tube and the bottom portion of the tube). As one example, in this implementation, the fastening means may comprise one or more fasteners (e.g., screws) that can be selectively passed through a via in the top wall and secured to the container body, such as in a fastener receiving opening (e.g., a threaded female opening). In this example, a top portion of the fastener may comprise a head that is larger than the via, such that the head remains on a top side of the top wall, thereby securing the top wall to the container body. That is, for example, a lid of the container may be fastened to the container body by fastening screws, screwed through the top of the lid, into receiving threads in the container body.

As another example, in this implementation, the fastening means may comprise one or more multi-piece fasteners, where a first piece may be attached to the top wall of the container and a second piece may be attached to the container body. In this example, the first piece and the second piece may be mated and mechanically secured together to provide the fastening means. That is, for example, the first piece may comprise a first shaped portion (e.g., a hook) that is configured to be selectively mated with a second shaped portion (e.g., an inverse hook) of the second piece; and a mechanical tightening portion of the first and/or second piece may be used to mechanically secure the top wall and container body together.

It will be appreciated that the apparatuses, described herein, are not limited to the implementation and examples described above. It is anticipated that those skilled in the art may devise alternate materials, shapes for the container, configurations for the tubes, sealing means for the top wall, and/or fastening means for the top wall. As an example, the cylinder shape of the container body may comprise a variety of shapes, such as a circle, oval, square, rectangle, etc. Further, as another example, the tube configuration may be arranged in any manner that can provide for efficient use of an interior space of the container. Additionally, there are a plurality of commonly available sealing means and/or fastening means (e.g., and those that may become available), any or all of which may be suitable for sealing and/or securing the top wall to the container body.

In one implementation of the apparatuses described herein, the tube inside the container may be filled (e.g., to a desired level and/or packing design) with a solid-source precursor that comprises a desired compound (e.g., desired to be transferred to a carrier gas, such as in vapor form). In this example, a carrier gas may be introduced to the solid-source precursor at the gas inlet, and the carrier gas (e.g., saturated with the desired compound) may be collected at the gas outlet, after traveling a winding route through the solid-source precursor filled in the tube. In this way, for example, a saturated carrier gas may be further utilized to transfer the desired compound to a desired receiving component (e.g., a film or layer of an integrated circuit, LED, etc.).

In one implementation, a type of filter may be placed at the gas inlet (e.g., prior to a location of the precursor material), and/or at the gas outlet (e.g., after a location of the precursor material). As one example, the filter may comprise a sintered metal frit, such as a sintered frit comprising stainless steel (e.g., or some other appropriate, non-reactive material). In this way, for example, an opportunity for precursor material (e.g., and/or components thereof) to be inadvertently introduced into the gas inlet and/or gas outlet can be mitigated. For example, “bubbling” the carrier gas through the precursor material may result in particles (e.g., and/or droplets) of the precursor material to become air-entrained, causing them to be introduced into the gas outlet, which is typically not desired. The filter placed at the gas outlet, for example, may mitigate introduction of these air-entrained particles to the gas outlet (e.g., and beyond).

In another aspect, in order to increase the travel route of the carrier gas through the precursor material, a bubbler container may be configured to receive a selectively removable routing structure. In one implementation, the routing structure may comprise one or more routing planes, one or more of which may comprise a route opening therein, which can be configured to direct a flow of gas in a desired route and/or direction. That is, for example, a routing plane of the routing structure may comprise an opening at a bottom portion of the plane, which, when inserted into the bubbling container, can direct the flow of the gas from a first side to a second side of the plane. In this example, the gas may flow in a downward direction on the first side, travel to the second side through the route opening, and flow upward at the second side. Using a bubbling container comprising precursor material and the routing structure of this example, a travel route of the gas can be increased through the precursor material.

In one implementation, the bubbler container may be configured to selectively receive the routing structure using one or more receiving slots disposed on a side wall of the container. As one example, where the routing structure comprises a first routing plane (e.g., comprised of 316L stainless steel), the side wall(s) of the container may comprise a first receiving slot on a first side of the side wall(s) and second receiving slot on a second side of the side wall(s). In this example, the routing structure may be inserted into the container by inserting a first end of the routing plane into the first receiving slot, and a second end of the routing plane into the second receiving slot. That is, for example, the routing structure may be inserted into place in the container by inserting the routing plane in the receiving slots and sliding it down into the container.

In one implementation, the routing structure may comprise a plurality of routing planes configured to direct a flow of the carrier gas in a deviating path through the precursor material (e.g., and longer path than a bubbler with the routing structure). As one example, a routing structure may comprise two intersecting planes (e.g., intersecting relatively orthogonally), thereby creating four chambers when inserted into the container. In this example, a gas flow may be introduced into a first chamber, such as through the gas inlet, and directed to the bottom of the first chamber.

Further, in this example, a first route opening may be disposed in a first routing plane at the bottom of the first chamber, which can direct the flow of gas from the first chamber to a second chamber, where it may directed upward. Additionally, in this example, a second route opening may be disposed in a second routing plane at the top of the second chamber, which can direct the flow of gas from the second chamber to a third chamber, where it may be direct downward. A third route opening may be disposed in a third routing plane at the bottom of the third chamber, which can direct the flow of gas from the third chamber to a fourth chamber, where it may directed upward, for example, and out through the gas outlet. In this way, for example, a carrier gas may travel a long and deviating path through a precursor material, thereby providing for improved saturation of a desired compound from the precursor to the gas, and/or improved consumption of the desired compound from the precursor, by the gas.

In one implementation, a first chamber formed by inserting the routing structure into the container may comprise a different dimension than a second chamber. As one example, the routing structure comprising two intersecting planes may be configured to create four chambers when inserted into the container, where respective chambers comprise a different dimension (e.g., size, volume). For example, the first chamber may comprise a first size, the second chamber a second size, the third chamber a third size and the fourth chamber a fourth size. In this example, the first size may be larger than the second size, which may be larger than the third size, which may be larger than the fourth size. That is, for example, the respective chambers, formed by inserting the routing structure into the container, may comprise a smaller volume the closer they are to the gas outlet (e.g., or inversely, the gas inlet).

In one implementation, in this aspect, the container may comprise a selectively removable top wall (e.g., as described above). Further, the container may comprise a fastening means (e.g., as described above) for selectively fastening the top wall to a container body of the container. Additionally, the container may comprise a top sealing means for sealing the top wall to the container body, and/or sealing the top wall to a top portion of the routing structure (e.g., as described above).

As one example, a top portion of the routing structure may comprise a top end of respective one or more routing planes. In order to efficiently direct the flow of gas along a desired route created by the routing structure, the top portion of the routing structure can be sealed against the bottom side of the top wall to mitigate undesired leaking of the gas past the top edge of a routing plane. In one implementation, the top sealing means may be disposed on the top wall, the top portion of the routing structure, or a combination of both.

As an example, the top sealing means may comprise a tight-fitting joint (e.g., a groove) where the top portion of the routing structure meets the bottom side of the top wall. As another example, the top sealing means may comprise one or more gaskets disposed on the top portion of the routing structure and/or on the bottom side of the top wall, where it meets the top portion of the routing structure. As another example, the top sealing means may comprise a combination of a tight-fitting seal and one or more gaskets. For example, one or more gaskets may be disposed on the top portion of the routing structure and a receiving groove may be disposed on the bottom side of the top wall where it meets the top portion of the routing structure. In this example, the gasket and groove may provide an appropriate seal for mitigating undesired leaking of gas past a routing plane, such as when the top wall is fastened to the container body.

In one implementation, the container may comprise a bottom sealing means for sealing a bottom portion of the routing structure to the bottom wall of the container. As one example, the bottom portion of the routing structure may comprise a bottom end of respective one or more routing planes. Similarly to the top portion, in order to efficiently direct the flow of gas along a desired route created by the routing structure, the bottom portion of the routing structure can be sealed against the top side of the bottom wall to mitigate undesired leaking of the gas past the bottom edge of a routing plane.

In one implementation, the bottom sealing means may be disposed on the top side of the bottom wall, the bottom portion of the routing structure, or a combination of both. As described above for the top portion, the bottom sealing means may comprise a tight-fitting joint where the bottom portion of the routing structure meets the top side of the bottom wall; one or more gaskets disposed on the bottom portion of the routing structure and/or on the top side of the bottom wall; and/or a combination of both.

In one implementation, the container may comprise a side sealing means for sealing a side portion of the routing structure to the side wall(s) of the container. As one example, the side portion of the routing structure may comprise a side end of respective one or more routing planes, which may contact an interior side of the side wall of the container. Similarly to the top portion and the bottom portion (described above), in order to efficiently direct the flow of gas along a desired route created by the routing structure, the side portion of the routing structure can be sealed against the interior side of the side wall(s) to mitigate undesired leaking of the gas past the side edge of a routing plane.

In one implementation, the side sealing means may be disposed on the interior side of the side wall(s) of the container, the side portion of the routing structure, or a combination of both. As described above for the top portion and the bottom, the side sealing means may comprise a tight-fitting joint where the side portion of the routing structure meets the interior side of the side wall(s); one or more gaskets disposed on the side portion of the routing structure and/or on the interior side of the side wall(s); and/or a combination of both.

In one implementation, the routing structure may be disposed in a basket assembly, for example, such that the routing structure may be selectively removed from and/or placed into the container by removing and/or placing the basket assembly. As one example, the routing structure may be attached (e.g., welded and/or sealed) into the basket assembly. In this example, the basket assembly may be configured (e.g., sized and shaped) to seat in the container, thereby effectively providing a selectively removable routing structure.

In one implementation, the basket assembly may comprise one or more side walls (e.g., forming a circular shape or a polygon shape) to which the side edges of the routing structure may be attached. As one example, the basket assembly may comprise an open bottom and top wall. In this example, the basket assembly can be placed into the container, where the container comprises a bottom wall sealing means and a top wall sealing means (as described above).

In another implementation, the basket assembly may comprise one or more side walls and a bottom wall attached to the side wall(s). In this implementation, for example, the bottom wall may also be attached to the bottom edges of the routing structure. In one implementation, the basket assembly may comprise a selectively removable top wall, such as a lid, which can be fastened to (e.g., and unfastened from) the side wall(s) of the basket assembly. For example, the basket assembly may comprise a type of container with a selectively removable lid, where the basket assembly container may be placed into (e.g., and remove from) the bubbler container assembly. In one implementation, the basket assembly side wall(s) and/or top wall may comprise a sealing means, such as described above.

In one implementation, the basket assembly top wall may comprise an inlet via and an outlet via, which can respectively align with the inlet tube and outlet tube of the bubbler assembly top wall. Further, in this implementation, at top portion of the top wall vias and/or a bottom portion of the bubbler assembly top wall, comprising the inlet tube and outlet tube respectively, may comprise a sealing means, such as described above. In this way, for example, leakage of the carrier gas outside of the desired route of travel (e.g., and/or the basket assembly or bubbler container) may be mitigated.

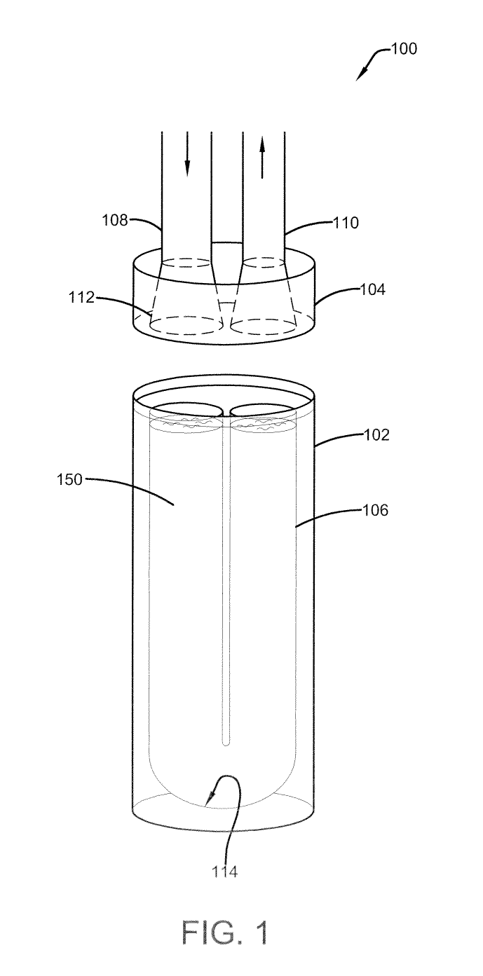

FIG. 1 is a component diagram illustrating an exemplary apparatus 100 for extracting a desired compound from a precursor material. As shown in the exemplary apparatus 100, a container 102 comprises a selectively removable top wall 104 (e.g., a lid). The container 102 is configured to house a bent tube 106 that is configured to contain a solid precursor material 150. In this exemplary apparatus 100, the tube 106 comprises a gas inlet 108, which may allow a carrier gas to flow into the container 102, and a gas outlet 110, which may allow the carrier gas to flow out of the container 102. Further, the tube 106 comprises a selectively removable top portion 112 that is configured to provide access to an interior portion 114 of the tube 106, such as to clean the tube 106 and/or to place the solid precursor material 150 into the tube 106.

As an example, the top wall 104 of the container 102 may be removed, and solid precursor material 105 may be placed into the tube 106 to a desired fill level. In this example, a carrier gas may be introduced to the solid precursor material 150 through the gas inlet 108, and the carrier gas can travel through the precursor material 150 in the tube 106, around a bend in the tube 106, and out the gas outlet 110. In this way, for example, a desired compound resident in the precursor material may be extracted (e.g., saturated) to the carrier gas (e.g., in vapor form), and collected at the gas outlet 110. Further, in this example, the top wall 104 may be subsequently removed in order to remove consumed precursor material 150 from the tube 106, and to clean the interior portion 114 of the tube 106.

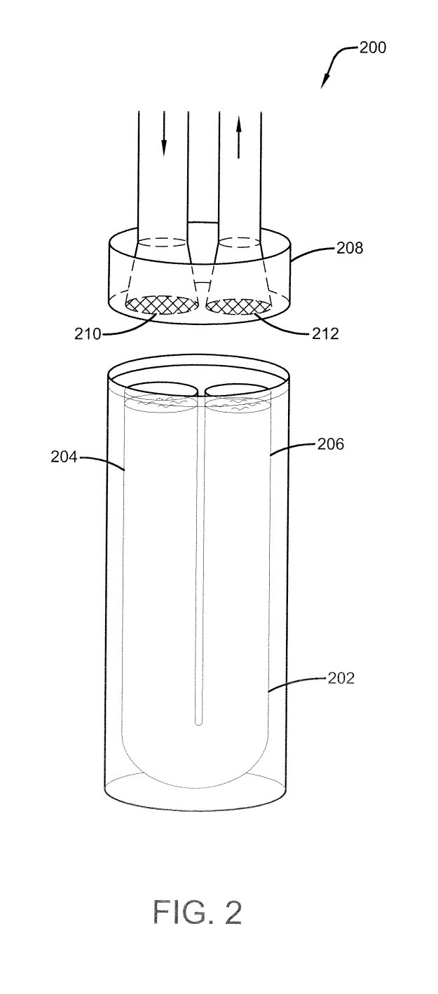

FIG. 2 is a component diagram illustrating an example implementation 200 where one or more portions of one or more apparatuses described herein may be implemented. In this implementation 200, a container 202 (e.g., 102 of FIG. 1) comprises a selectively removable top wall 208 (e.g., a lid). The container 202 can be configured to house a bent tube, where the tube comprises a first chamber 204 and a second chamber 206. In this example 200, the first chamber 204 and the second chamber 206 comprise different sizes (e.g., tube diameters). As an example, the first column 204 comprises a larger interior volume than the second column 206. In one implementation, the bent tube may comprise a plurality of chambers, where respective chambers are progressively smaller in size (e.g., interior volume, and/or diameter) than a previous chamber from the inlet to the outlet.

Further, in this example implementation, a first filter 210 may be disposed at the gas inlet, such as prior to a portion of the bent tube comprising the precursor material. Additionally, a second filter 212 may be disposed at the gas outlet portion of the bent tube, such as after the portion of the bent tube comprising the precursor material. In this way, for example, the filters 210, 212 may mitigate introduction of the precursor material into the gas inlet and/or outlet. As one example, the filters 210, 212 may comprise a non-reactive type material of appropriate pore size to mitigate particle infiltration, such as a sintered metal frit comprising stainless steel (e.g., or some other non-reactive material).

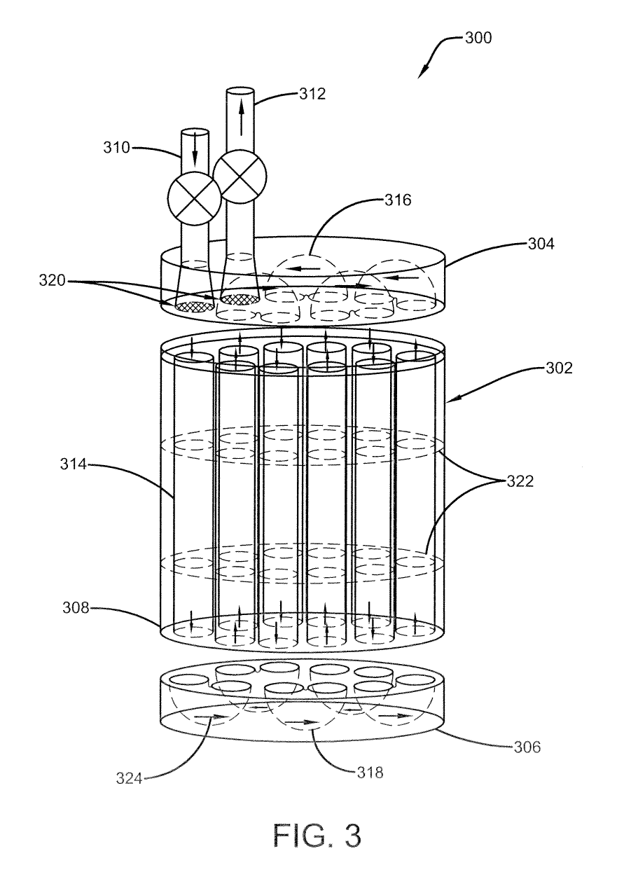

FIG. 3 is a component diagram illustrating an example implementation 300 where one or more portions of one or more apparatuses described herein may be implemented. In the example implementation 300, the container 302 comprises a selectively removable top wall 304, a bottom wall 306, and a side wall 308. In one implementation, the side wall 308 of the container 302 may be attached (e.g., welded) to the bottom wall 306, for example, to facilitate manufacture of the container 302. Further, the container 302 can comprise a bent tube 314 comprising a plurality of chambers (e.g., comprising respectively smaller interior volumes), one or more top bends 316, and one or more bottom bends 318. Additionally, the tube can comprise a gas inlet 310 and a gas outlet 312.

In this example, a top portion of the tube 314, comprising the top bends, can be selectively removable. In one implementation, the top portion of the tube 314 may be attached to the selectively removable top wall 304. As one example, when the top wall 304 is removed from the container 302, such as for cleaning and/or loading the tube 312, the top portion of the tube 304 may also be removed to access an interior portion of the tube 312.

In this example 300, a gas flow direction 324 indicates how a carrier gas, introduced at the gas inlet 310, can travel through the tube in a long and deviating path. In this way, for example, the carrier gas may be exposed to the precursor material (not shown) resident in the tube 314 for a longer time, thereby providing for an improved saturation of a desired component to the carrier gas, and/or an improved consumption of the desired material from the precursor material. Further, in this example, 300, sintered metal frits 320 may be disposed at the gas inlet 310 and gas outlet 312 to mitigate entrainment of the precursor material outside of the container.

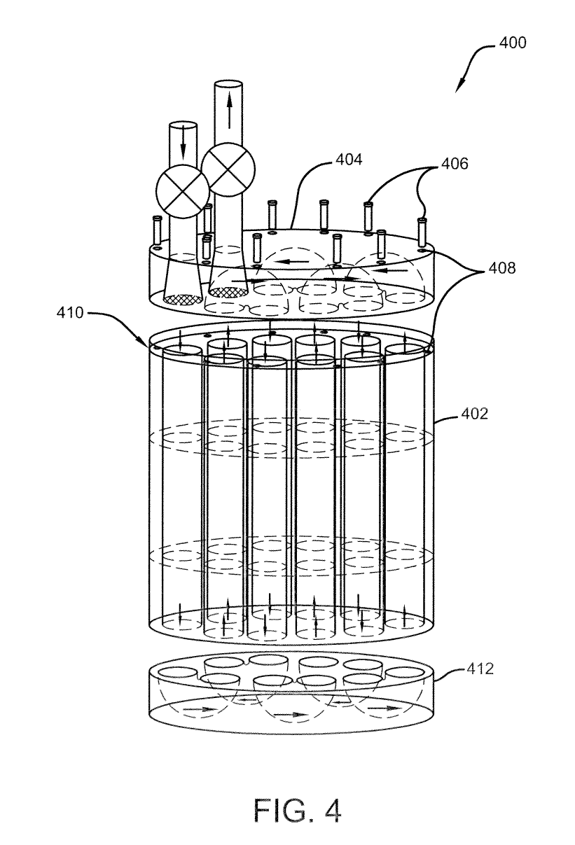

FIG. 4 is a component diagram illustrating an example implementation 400 where one or more portions of one or more apparatuses described herein may be implemented.

In this example 400, the container 402 can comprise the selectively removable top wall (e.g., attached to the top portion of the tube). Further, in this example 400, a fastening means can comprise fasteners 406 (e.g., screws, bolts, etc.), which may be fastened to the body of the container 402 through vias 408, where a bottom via comprises a receiving via configured to receive the fastener (e.g., a female threaded hole to receive the bolt or screw). Additionally, the top wall 404 and/or body portion of the container 402 can comprise a sealing means 410. As an example, the lid 404 and body may have a tight fitting seal where they meet. As another example, the lid 404 and/or body may comprise a type of gasket that provides a seal when the lid and body are fastened together. In one implementation, the bottom wall 412 may be selectively removed, and/or fastened in a similar manner at the top wall 404.

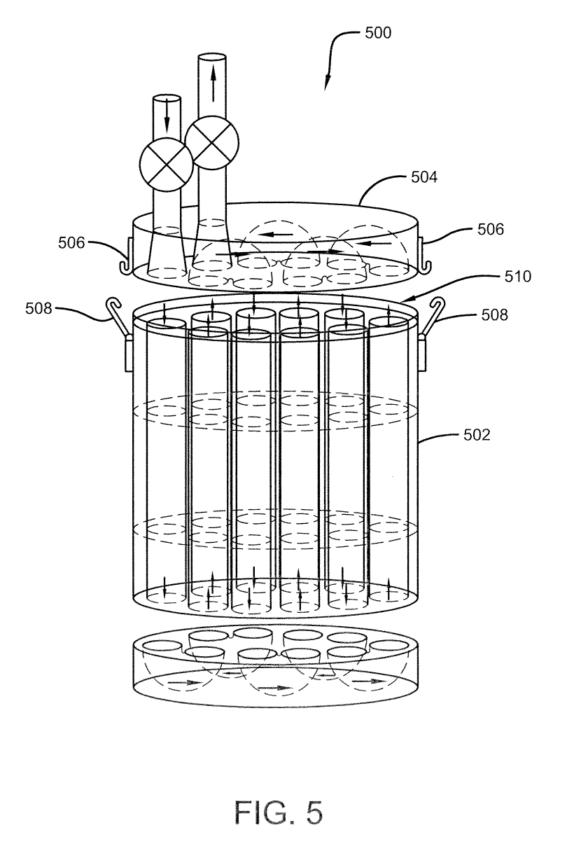

FIG. 5 is a component diagram illustrating an example implementation 500 where one or more portions of one or more apparatuses described herein may be implemented. In the example implementation 500, an alternate fastening means may be provided. In one implementation, the fastening means may comprise a two (or more) piece fastening structure 506, 508, where a first portion of the fastening structure 506 is resident on the top wall 504 and a second portion 508 of the fastening structure is resident on the body of the container 502. As an example, the second portion 508 may couple with the first portion 506 (e.g., hook together), and a tightening portion (not shown) of the fastening means may be tightened to fasten the top wall 504 to the body of the container 502. Further, the container 502 may comprise the sealing means 510, as described above.

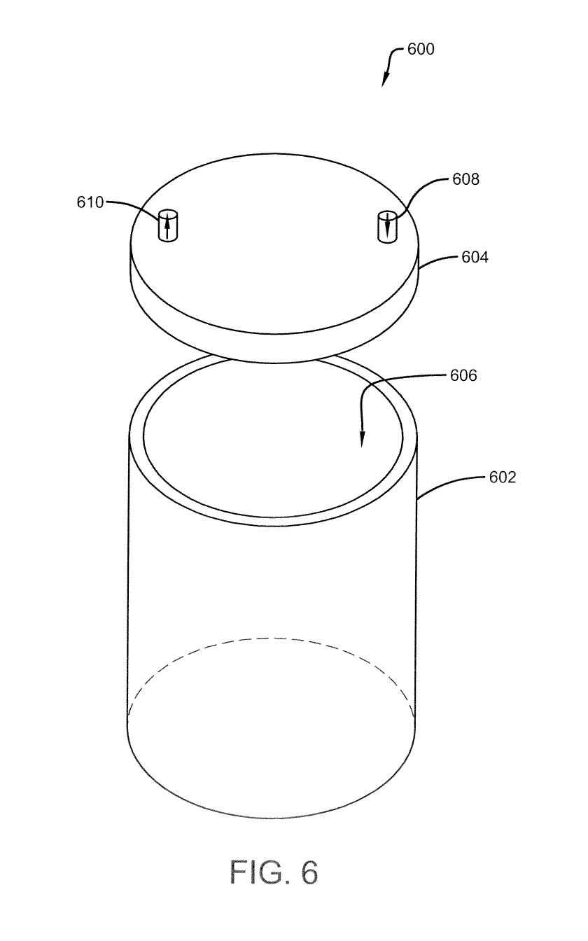

FIG. 6 is a component diagram illustrating an example implementation 600 where one or more portions of one or more apparatuses described herein may be implemented. In one implementation, a bubbler assembly may comprise a container body (e.g., comprising a bottom wall and one or more side walls), a selectively removable top wall, and a selectively removable routing structure. In the example 600, a container body 602 comprises and interior portion 606 that may be configured to receive the removable routing structure (not shown). Further, a top wall 604 may comprise a gas inlet 610 and a gas outlet 608. In one implementation, the container body 602 and/or the top wall 604 may comprise a sealing means (not shown), such as a gasket, where the container body 602 and the top wall 604 meet.

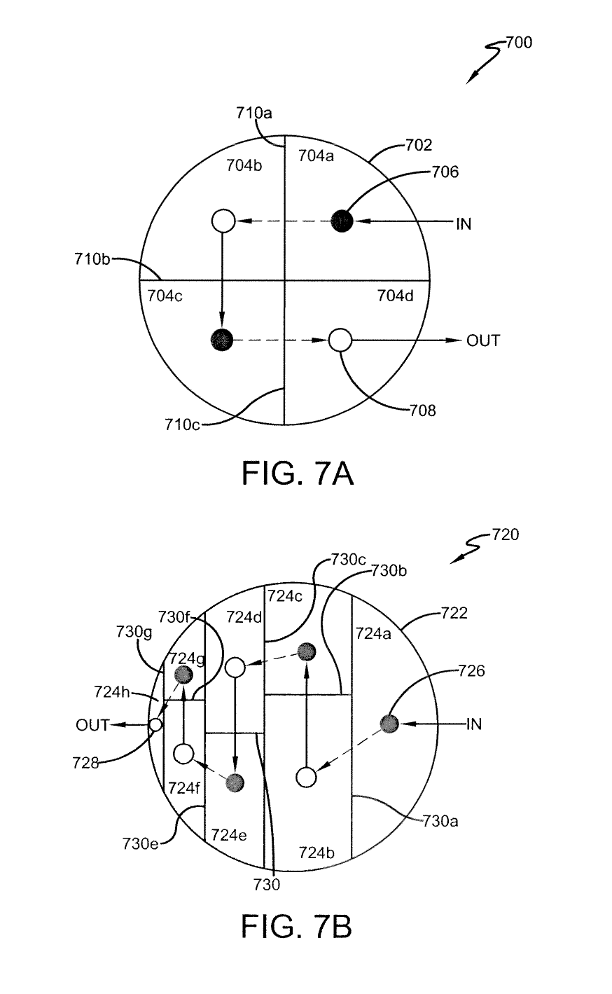

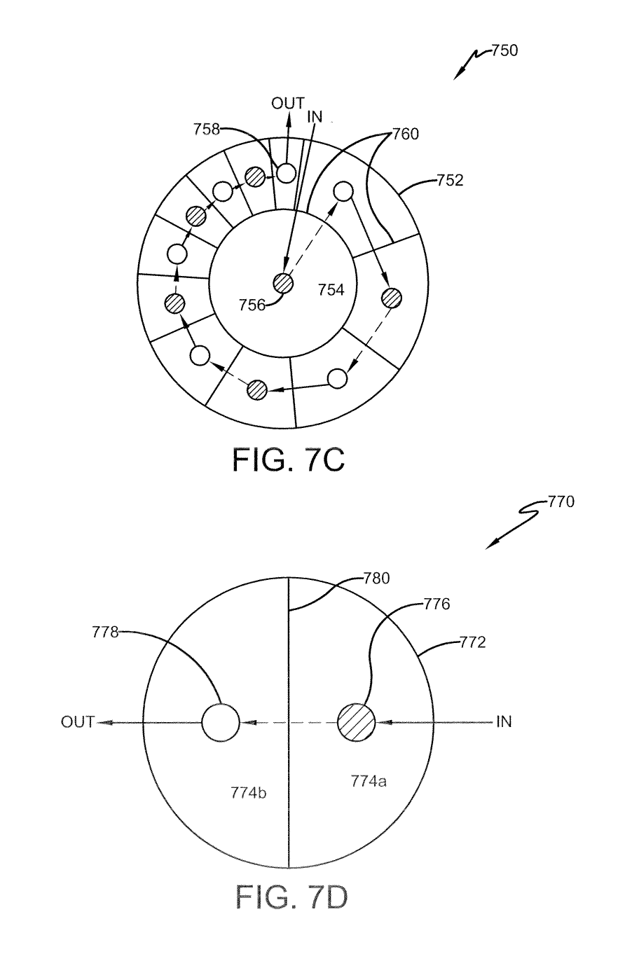

FIGS. 7A-7D are component diagrams illustrating example implementations 700, 720, 750, 770 where one or more portions of one or more apparatuses described herein may be implemented. In the example implementation 700, a top view of an example routing structure is illustrated. In this example, a side wall 702 of the container body (e.g., 602 of FIG. 6) can be configured to receive the routing structure. For example, the routing structure can comprise one or more routing planes 710, which may be received by one or more receiving slots (not shown) disposed on an interior portion of the side wall 702 of the container. When the routing structure is inserted into the container body, in this example 700, four chambers 704 may be created, respectively configured to comprise precursor material.

In the example implementation 700, one or more of the routing planes may comprise a route opening therein, which can be configured to direct a flow of gas in a desired route and/or direction. For example, a gas may be introduced through a gas inlet 706 into a first chamber 704a, where the gas can travel downward (e.g., through the precursor material). At a bottom portion of the routing plane 710a, a first route opening (not shown) may be disposed that allows the gas to flow from the first chamber 704a to a second chamber 704b, where it may flow upward (e.g., through the precursor material). At a top portion of the routing plane 710b, a second route opening may be disposed that allows the gas to flow from the second chamber 704b to a third chamber 704c, where the gas may flow downward. A third routing opening may be disposed in the third routing plane 710c, allowing the gas to flow into a fourth chamber 704d, and upward to a gas outlet 708.

In the example implementation 720 of FIG. 7B, an alternate routing structure arrangement is illustrated. In this example, the side wall 722 of the container body can be configured to receive the alternate routing structure arrangement (e.g., where the side wall comprises appropriately matching receiving slots). In the example implementation 720, the respective chambers 724 comprise a smaller size (e.g., volume) than a previous chamber, from the gas inlet 726 to the gas outlet 728. In one implementation, a gas may be introduced to a first chamber 724a at the gas inlet 726, flow to a second chamber 724b through a first routing opening at the bottom of a first routing plane 730a, flow to a third chamber 724c through a second route opening at the top of a second routing plane 730b, and so-on, until the gas flows out from a last chamber 724h, through the gas outlet 728.

In the example implementation 750 of FIG. 7C, another alternate routing structure arrangement is illustrated. In this example, the side wall 752 of the container body can be configured to receive the routing structure arrangement. The chambers 754 created by inserting the routing structure into the container body 752 can comprise progressively smaller volumes from the gas inlet 756 to the gas outlet 758. Further, route openings may be disposed in one or more respective routing planes 760 at a desired location (e.g., at the top or bottom), for example, in order to direct the gas along a desired routing route. In this way, a desired length of the routing route may be created by adding or removing routing planes, arranging the routing planes in a desired configuration, and/or arranging the routing opening in appropriate locations along the respective routing planes.

In the example implementation 770 of FIG. 7D, another alternate routing structure arrangement is illustrated. In this example, the side wall 772 of the container body can be configured to receive merely a single routing plane 780. In this implementation gas introduced at a gas inlet 776 may travel downward in a first chamber 774a to a route opening not shown) at the bottom of the routing plane 780. Further, the gas can flow through the route opening into a second chamber 774b, and upward to the gas outlet 778.

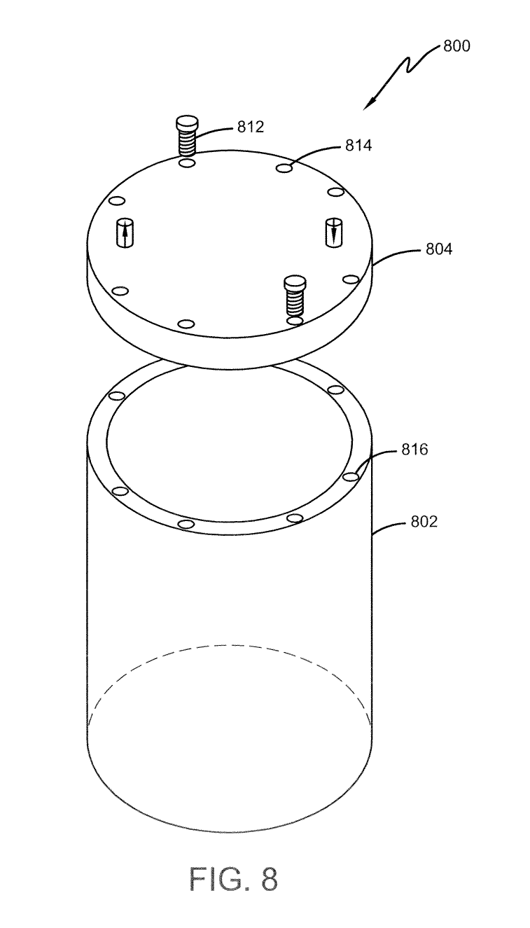

FIG. 8 is a component diagram illustrating an example implementation 800 where one or more portions of one or more apparatuses described herein may be implemented.

In this implementation 800, an example bubbler container can comprise a container body (e.g., configured to receive a routing structure) and a selectively removable top wall 804. Further, the example bubbler container can comprise a fastening means that is configured to fasten the top wall 804 to the container body 802. In this example, the fastening means can comprise one or more fasteners 812 that are configured to pass through a via 814 and be securely received by a receiving portion 816. As one example, the fastener 812 may facilitate in securing the top wall 804 by screwing into the receiving portion 816, through the via 814, where the fastener 812 comprises a head larger than the via 814. It is anticipated that alternate fastening means may be utilized by those skilled in the art. Further, the example bubbler container may comprise a sealing means, as described above (e.g., a gasket).

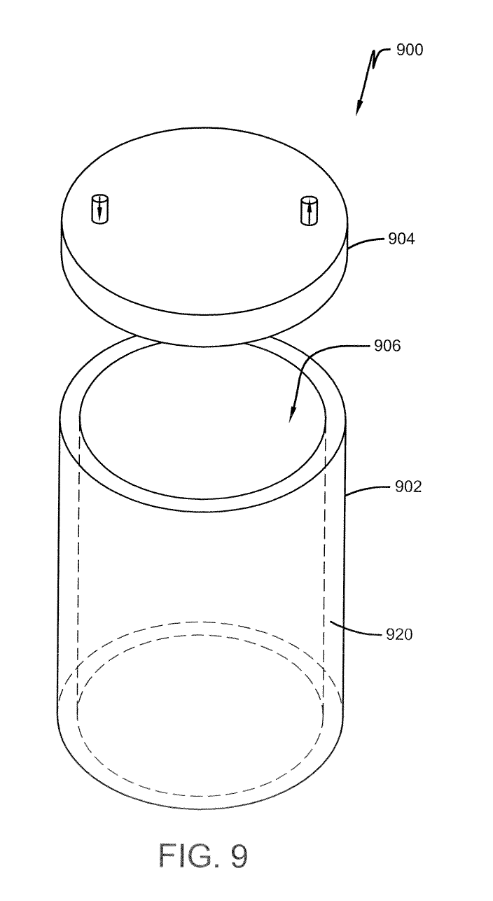

FIG. 9 is a component diagram illustrating an example implementation 900 where one or more portions of one or more apparatuses described herein may be implemented. In one implementation, the container body 902 may comprise a desired wall thickness 920, defined by the exterior of the container body and an interior 906 of the container body. In one implementation, the wall thickness 920 may vary from a top portion of the container body 902 to a bottom portion of the container body 902. For example, the top portion of the container body 902 may comprise a larger wall thickness 920 than a lower portion of the container body 902. In this way, in this example, the container body 902 may be appropriately configured such that a top wall 904 may be fastened to the container body 902 (e.g., for attaching fastening means).

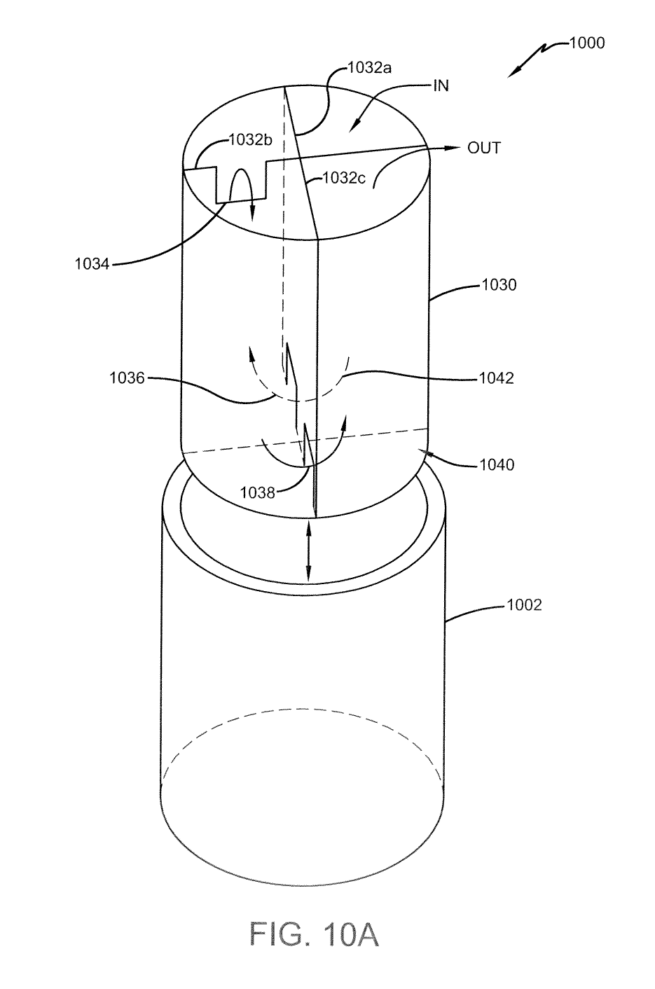

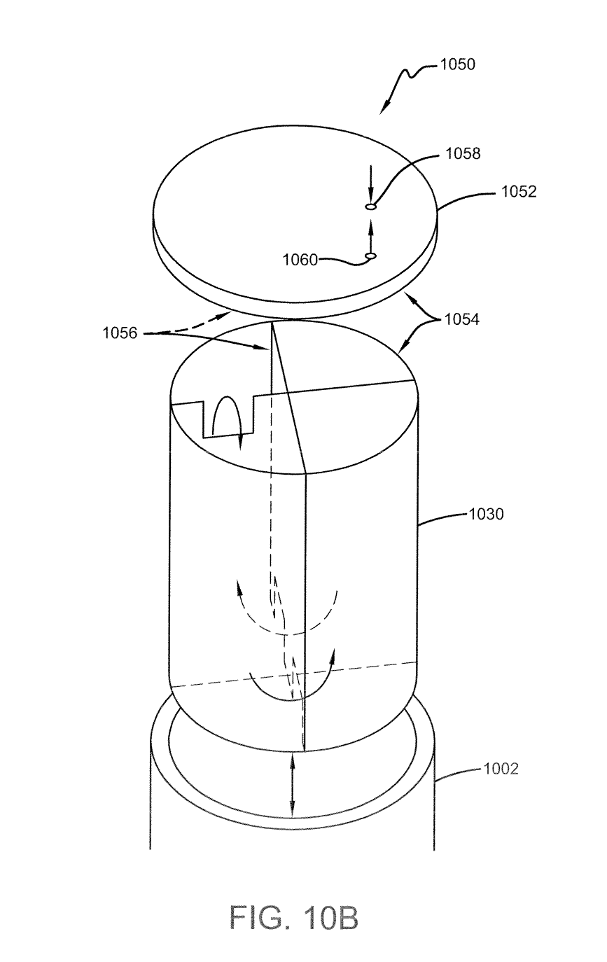

FIGS. 10A and 10B are component diagrams illustrating example implementation 1000, 1050 where one or more portions of one or more apparatuses described herein may be implemented. In the implementation 1000 of FIG. 10A, the selectively removable routing structure may be comprised in a basket assembly 1030 that can be configured to provide for the routing structure to be selectively removed from and/or placed into the container by removing and/or placing the basket assembly 1030. In one implementation, the routing structure may be attached (e.g., welded) to the basket assembly 1030, for example, by attaching a side portion of respective routing planes 1032 to an interior portion of the basket assembly 1030.

In one implementation, the basket assembly may comprise a bottom plane 1040 (e.g., bottom wall), for example, that may provide for containing a precursor material within the basket assembly 1030. In another implementation, the bottom plane 1040 may not be present in the basket assembly 1030, for example, wherein the precursor material may be contained inside the container body 1002. In this example, the basket assembly 1030 may be selectively inserted into the container body 1002, effectively inserting the routing structure through the precursor material (e.g., and dividing the precursor material amongst respective chambers of the routing structure).

In the example implementation 1000, a first route opening 1036 is disposed at the bottom of the first routing plane 1032a, a second route opening 1034 is disposed at the top of a second routing plane 1032b, and a third route opening 1038 is disposed at the bottom of a third routing plane 1032c. In this way, for example, a route 1042 of a carrier gas introduced into the routing structure (e.g., in the container body 1002) may go downward through the first route opening 1036, up through the second route opening 1034 down through the third route opening 1038 and out (e.g., through the gas outlet).

In the example implementation 1050 of FIG. 10B, the basket assembly 1030 may further comprise a selectively removable top wall 1052 (e.g., lid). As an example, the basket assembly top wall 1052 may be fastened (e.g., using a fastening means, such as described above, and/or using a tight fitted, friction-based fastening means) to the side wall(s) of the basket assembly 1030, and the entire basket assembly (e.g., comprising precursor material) may be inserted into (e.g., and removed from) the bubbler assembly container 1002.

In one implementation, the basket assembly top wall 1052 and/or the basket assembly side wall(s) may comprise a wall edge sealing means 1054, such that the top wall may be appropriately sealed to the side walls to mitigate leakage of carrier gas from inside to the outside of the basket assembly, and/or leakage of contaminants from outside to the inside of the basket assembly. The wall edge sealing means 1054 may comprise a tight fitted seal, and/or a gasket of an appropriate (e.g., non-reactive) material, as described above. In one implementation, the top edge of the routing structure and/or the bottom side of the basket assembly top wall 1052 may comprise a sealing means 1056, such as described above. Additionally, the basket assembly top wall 1052 may comprise an inlet via 1058 and an outlet via 160. In one implementation, the respective vias 1058, 1060 may comprise a sealing means between the vias 1058, 1060 and the gas inlet (e.g., 610 of FIG. 6) and gas outlet (e.g., 608 of FIG. 6), respectively, of the bubbler container top wall (e.g., 604 of FIG. 6).

Various operations of implementations are provided herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. An apparatus for running a gas through precursor material, comprising:
a container comprising a selectively removable top wall, the container configured to house a bent tube, the tube configured to contain a solid precursor material, the tube comprising:
a gas inlet;
a gas outlet; and
a selectively removable top portion configured to provide access to an interior portion of the tube.

2. A system for running a gas through precursor material, comprising:
a container comprising a selectively removable top wall, the container configured to receive a routing structure, the routing structure configured to:
be selectively removable from the container; and
direct a flow of the gas through the precursor material using a desired route.
